(19) United States
(12) Patent Application Publication
(10) Pub. No.: US 2025/0148008 A1
(43) Pub. Date: May 8, 2025

(54) VIDEO DISPLAY METHOD AND APPARATUS, ELECTRONIC DEVICE, AND STORAGE MEDIUM

(71) Applicant: Beijing Zitiao Network Technology Co., Ltd., Beijing (CN)

(72) Inventors: Xiaowei HU, Beijing (CN); Ying WANG, Beijing (CN); Cheng YANG, Beijing (CN)

(21) Appl. No.: 18/837,580

(22) PCT Filed: Feb. 8, 2023
(86) PCT No.: PCT/CN2023/074994

§ 371 Date: Aug. 9, 2024

(30) Foreign Application Priority Data
Feb. 10, 2022 (CN) 202210124167.3

(51) Int. Cl. G06F 16/74; G06F 3/0482; G06F 3/0484; G06F 16/735

(52) U.S. Cl. CPC G06F 16/74; G06F 3/0482; G06F 3/0484; G06F 16/735

(57) ABSTRACT

The embodiments of the present disclosure provide a video display method and apparatus, an electronic device and a storage medium. The method comprising: in response to a first media item comprising a first preset object being played, determining whether a second preset object associated with the first media item meets a preset condition; in response to the second preset object associated with the first media item meeting the preset condition, displaying a preset identifier on a playing screen of the first media item; and in response to a triggering acting on the preset identifier, displaying at least one second media item, wherein the at least one second media item is at least one media item associated with the first preset object, which is determined based on associated information of the first media item.

### CROSS-REFERENCE TO RELATED APPLICATIONS

This application is a U.S. National Stage Application under 35 U.S.C. § 371 of International Patent Application No. PCT/CN2023/074994, filed on Feb. 8, 2023, which is based on and claims the benefit of priority to the Chinese patent application No. 202210124167.3 filed on Feb. 10, 2022, the disclosures of both of which are hereby incorporated by reference in its entirety into the present application.

### TECHNICAL FIELD

The present disclosure relates to the field of information technology, and in particular to a video display method and apparatus, an electronic device and a storage medium.

### BACKGROUND

With the rapid development of network technology and mobile terminal technology, there are more and more applications suitable for mobile terminals. For example, video applications, based on which users can watch videos.

In some application scenarios, it is expected to provide users with more convenient services. For example, when a user watches a local food-related video, a POI (Point of Interest) of a restaurant corresponding to a current food usually will be displayed on a playing screen of the video, and the user can enter a restaurant page corresponding to the current food in the video by triggering the POI, thereby providing the user with more convenient services.

### SUMMARY

According to some embodiments of the present disclosure, a video display method applied to a target terminal is provided, comprising:
in response to a first video comprising a first preset object being played, determining whether a second preset object associated with the first video meets a preset condition;
in response to the second preset object associated with the first video meeting the preset condition, displaying a preset entrance identifier on a playing screen of the first video; and
in response to a triggering acting on the preset entrance identifier, displaying at least one second video, wherein the at least one second video is at least one video associated with the first preset object, which is determined based on associated information of the first video.

According to other embodiments of the present disclosure, a video displaying device is also provided, comprising:
a first determining module configured to, in response to a first video comprising a first preset object being played, determine whether a second preset object associated with the first video meets a preset condition;
a first displaying module configure to in response to the second preset object associated with the first video meeting the preset condition, display a preset entrance identifier on a playing screen of the first video; and
a second displaying module configured to in response to a triggering acting on the preset entrance identifier, display at least one second video, wherein the at least one second video is at least one video associated with the first preset object, which is determined based on associated information of the first video.

According to another embodiments of the present disclosure, an electronic device is also provided, comprising:
a processor;
a storage device, for storing a computer program;
wherein the computer program, when executed by the processor, causes the processor to implement the video display method as provided in any of embodiments of the present disclosure.

According to further embodiments of the present disclosure, a computer-readable storage medium is also provided, on which a computer program is stored, wherein the computer program, when executed by a processor, causes the processor to implement the video display method as provided in any of embodiments of the present disclosure.

### BRIEF DESCRIPTION OF THE DRAWINGS

By combining the accompanying drawings and referring to the following Detailed Description, the above and other features, advantages, and aspects of each embodiment of the present disclosure will become more apparent. Throughout the accompanying drawings, the same or similar drawing reference signs indicate the same or similar elements. It should be understood that the accompanying drawings are illustrative, and elements may not necessarily be drawn to scale relative to the originals.

FIG. 1 is a flowchart of a video display method provided in some embodiments of the present disclosure.

FIG. 2 is a schematic diagram of a playing page of a first video provided in some embodiments of the present disclosure.

FIG. 3 is a schematic diagram of a preset entrance identifier displayed on a playing screen of the first video provided in some embodiments of the present disclosure.

FIG. 4 is a schematic diagram of a page displaying a second video provided in some embodiments of the present disclosure.

FIG. 5 is a schematic diagram of an associated page provided in some embodiments of the present disclosure.

FIG. 6 is a schematic structural diagram of a video displaying apparatus provided in some embodiments of the present disclosure.

FIG. 7 is a schematic structural diagram of an electronic device provided in some embodiments of the present disclosure.

### DETAILED DESCRIPTION

A more detailed description of the embodiments of the present disclosure will be provided below with reference to the accompanying drawings. Although certain embodiments of the present disclosure are shown in the accompanying drawings, it should be understood that the present disclosure can be realized in various forms and should not be construed as limited to the embodiments described herein. Instead, these embodiments are provided for a more thorough and complete understanding of the present disclosure. It should be understood that the accompanying drawings and embodiments of the present disclosure are for illustrative purposes only rather than limiting the protection scope of the present disclosure.

It should be understood that various steps recorded in the embodiments of the disclosed methods can be executed in different orders and/or in parallel. In addition, the method implementation can comprise additional steps and/or omit executing the shown steps. The scope of the present disclosure is not limited in this regard.

The term “comprise” and its variations used herein are nonexclusive inclusion, meaning “comprising but not limited to”. The term “based on” means “at least partially based on”. The term “one embodiment” means “at least one embodiment”; the term “another embodiment” means “at least one other embodiment”; the term “some embodiments” means “at least some embodiments”. The relevant definitions of other terms will be provided in the following description.

It should be noted that the concepts such as “first”, “second”, etc., mentioned in the present disclosure are only used to distinguish different devices, modules or units rather than to limit the order or interdependence of the functions performed by these devices, modules or units.

It should be noted that the modifications of “one” and “multiple” mentioned in the present disclosure are illustrative rather than restrictive, and those skilled in the art should understand that unless otherwise explicitly stated in the context, they should be understood as “one or more”.

Names of messages or information exchanged between multiple devices in the implementations of the present disclosure are for illustrative purposes only rather than limiting the scope of these messages or information.

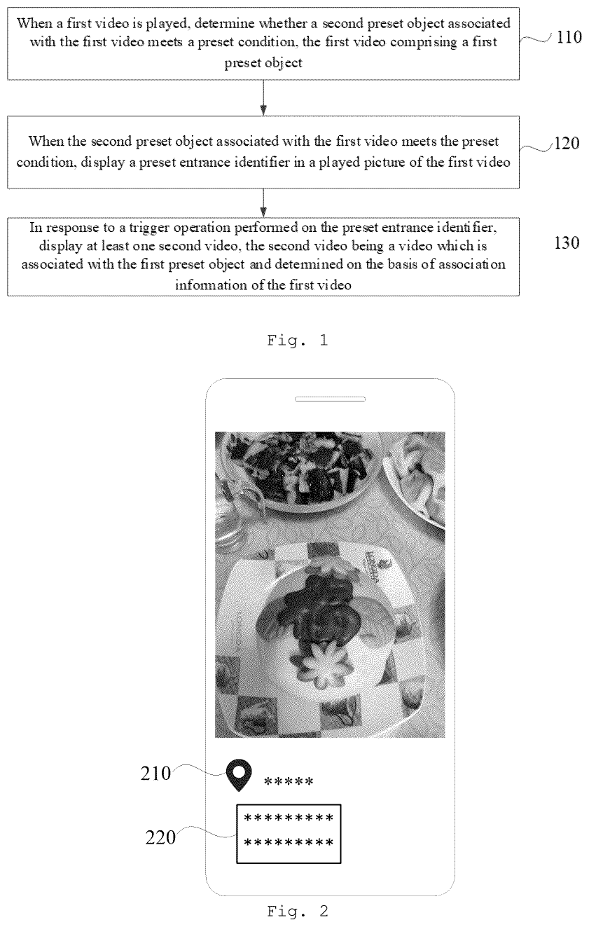

FIG. 1 is a flowchart of a video display method provided in some embodiments of the present disclosure. The present embodiment is applicable to a client that is installed in a target terminal. Specifically, a relevant video is recommended to a user based on a video(s) that is watching by the user, aiming at recommending convenient life services to the user and achieving a purpose of improving user experience. The method can be executed by a video displaying apparatus, which can be realized in the form of software and/or hardware. The video displaying apparatus can be set in an electronic device, such as a terminal, comprising but not limited to a smart phone, a palmtop computer, a tablet computer, a wearable device with display screen, a desktop computer, a notebook computer, an all-in-one machine, a smart home device and the like.

As shown in FIG. 1, the method in particular comprises the following steps: steps 110-130.

In step 110, in response to a first video comprising a first preset object being played, whether a second preset object associated with the first video meets a preset condition is determined.

It can be understood that the first video can be a non-real-time live video or a live video, which is not limited in this application.

In some embodiments, the second preset object associated with the first video can be a target interest point associated with the first video. For example, if the first video is about grilled fish, it is determined that the target interest point associated with the first video is a position identifier of an associated restaurant when the first video is posted, and further whether the restaurant meets the preset condition is judged. For another example, if the first video is about hairdressing and styling, it is determined that the target interest point associated with the first video is a position identifier of an associated hairdressing shop for hairdressing and styling when the first video is posted, and whether the hairdressing shop meets the preset condition is judged.

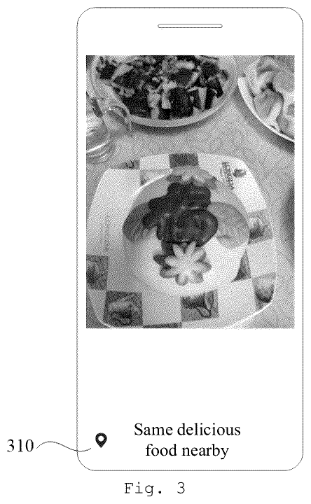

In some embodiments, the second preset object associated with the first video can be displayed on a playing page of the first video. For example, referring to the schematic diagram of a playing page of the first video as shown in FIG. 2, a second preset object 210 associated with the first video is displayed on the playing page. By triggering the second preset object 210, it can be achieved to jump from the playing page of the first video to a page where the second preset object 210 is located. Usually, an associated area 220 of a display position of the second preset object 210 will also display some text information that is used as an introduction to a subject of the first video. Further, the first video comprises the first preset object that can be food or fine styling, etc. The first preset object can be obtained by performing image recognition on video frames of the first video or obtained through related annotation information of the first video, which is added in advance.

In some embodiments, taking that the second preset object associated with the first video is the target interest point associated with the first video as an example, the determining whether the second preset object associated with the first video meets the preset condition comprises: determining whether the target interest point associated with the first video is outside a preset range determined based on the target terminal; and in response to determining that the target interest point associated with the first video is outside the preset range determined based on the target terminal, determining that the second preset object associated with the first video meets the preset condition. For example, the target interest point associated with the first video is a restaurant whose geographical location is outside a preset range based on a geographical location determined by a target terminal. That is, when the target interest point associated with the first video and the target terminal are not in a same preset range, it is considered that the second preset object associated with the first video meets the preset condition. It should be noted that the geographic location of the target terminal is determined under a condition of obtaining a full authorization from a user.

In step 120, in response to the second preset object associated with the first video meeting the preset condition, a preset entrance identifier is displayed on a playing screen of the first video.

For example, when the target interest point associated with the first video is outside the preset range determined based on the target terminal, the preset entrance identifier is displayed on the playing screen of the first video.

It is generally believed that if the target interest point and the target terminal are not in a same preset range, a current user (namely, a user who operates the target terminal) is not motivated to trigger the target interest point, mainly because the current user cannot experience a convenient service associated with the target interest point in time. For example, a gourmet restaurant located by the target interest point is far away from the current user, and even if the current user is interested in food in this gourmet restaurant, the current user cannot enjoy the food in a short time. Based on this, the preset entrance identifier is displayed on the playing screen of the first video, so that in response to the preset entrance identifier being triggered, at least one second video is displayed, which is at least one video associated with the first preset object, which is determined based on associated information of the first video. For example, if the first video is a video about food of grilled fish, then the second video is a video about same food of grilled fish.

Further, a third preset object associated with the second video is within the preset range determined based on the target terminal, and the third preset object is the target interest point associated with the second video, so that the current user can experience a convenient service associated with the second preset object, namely the target interest point, in time. Specifically, for example, a gourmet restaurant located by the target interest point associated with the second video is close to the current user, and if the current user is interested in food in this gourmet restaurant, the current user can enjoy the food in a short time.

Therefore, by limiting a display condition of the above preset entrance identifier, a trigger rate of the preset entrance identifier can be improved, and the current user can experience the convenient service associated with the second preset object in the second video in time, thereby achieving a purpose of improving user experience.

In some embodiments, the method further comprises, before displaying the preset entrance identifier on the playing screen of the first video: determining whether the preset entrance identifier is displayed through a first preset model, based on a first feature of a current user and a second feature of the first video, wherein the current user is a user operating the target terminal, and in response to determining that the preset entrance identifier is displayed, the displaying the preset entrance identifier on the playing screen of the first video is performed.

For example, the first feature of the current user can be a feature determined based on historical behaviors of the current user, such as public comment operation. The second feature of the first video can be, for example, a subject feature of the first video, a feature of the first preset object in the first video, a feature of the second preset object associated with the first video, and the like.

Further, the preset entrance identifier can comprise a keyword associated with the first preset object. For example, if the first preset object is food, the preset entrance identifier can comprise a category text of the food, for example, a keyword such as grilled fish, hotpot, etc.

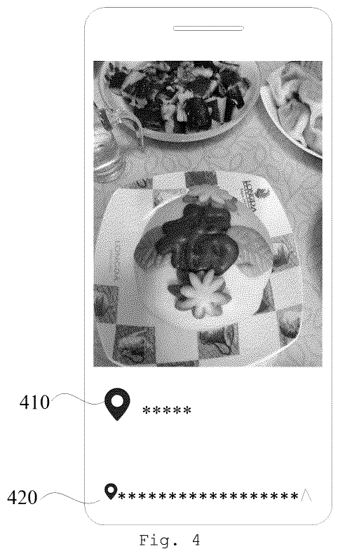

Illustratively, referring to a schematic diagram of a preset entrance identifier displayed on a playing screen of a first video as shown in FIG. 3, which comprises a preset entrance identifier 310 that can in particular comprise the words “same delicious food nearby”.

In step 130, in response to a triggering acting on the preset entrance identifier, at least one second video is displayed, wherein the at least one second video is at least one video associated with the first preset object, which is determined based on associated information of the first video.

By determining the second video associated with the first preset object based on the association information of the first video, the second video can have a high correlation with the first video, thereby improving user consumption experience.

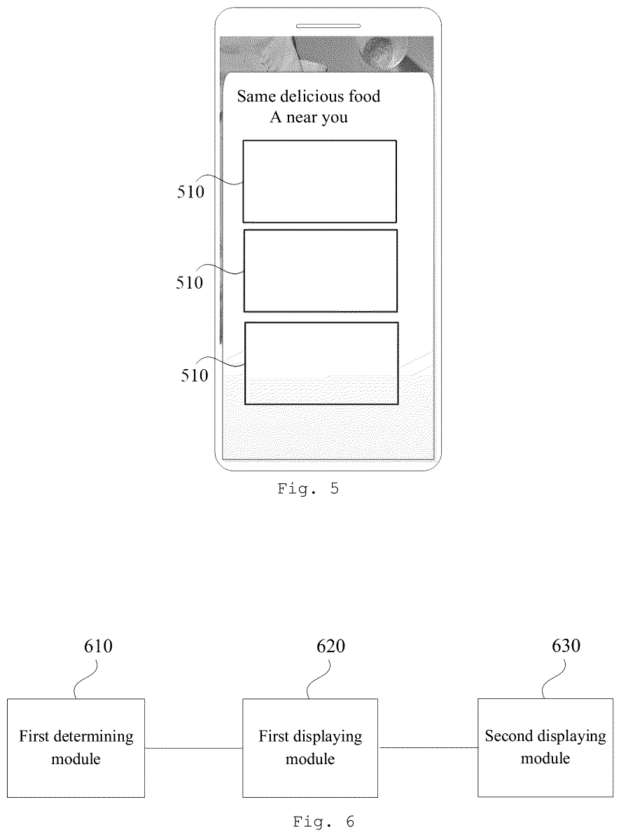

Illustratively, after the preset entrance identifier as shown in FIG. 3 is clicked, an interface shown in FIG. 4 can be jump to. In a schematic diagram of the interface displaying a second video as shown in FIG. 4, which comprises a third preset object 410 and a preset list entrance identifier 420, the second video comprises a first preset object in a first video. For example, if the first preset object in the first video is food A, the second video is a video comprising A. When the preset list entrance identifier 420 is triggered, an associated page as shown in FIG. 5 is displayed, which comprises an information list associated with the first preset object in the first video. For example, if the first preset object in the first video is food A, what the associated page shown in FIG. 5 displays is a list of restaurants with food A near the current user, and each list item 510 comprises detailed information such as an address, per capita consumption, and the like of a restaurant of the above restaurants.

In some embodiments, the method further comprises: in response to displaying the preset entrance identifier on the playing screen of the first video, determining a related video set based on associated information of the first video, wherein the at least one second video is at least one video in the related video set, and the associated information of the first video comprises a tag corresponding to the first preset object in the first video, a text feature associated with the first video, a screen feature of the first video and a preset range feature where the target terminal is located.

The tag corresponding to the first preset object is, for example, a category to which the first preset object belongs, such as hot pot, buffet, western food, etc. The text feature associated with the first video can be a title of the first video. The screen feature of the first video can be screen content of the first video. For example, if the playing screen of the first video comprises food B, the screen feature can be determined as “food B”. The preset range feature where the target terminal is located refers to geographical location information obtained based on the target terminal, and a living service nearby can be recommended to the current user based on the preset range feature.

In some embodiments, the determining a related video set based on associated information of the first video comprises: inputting the associated information of the first video into a second preset model to obtain the related video set; or based on a similarity between the associated information of the first video and associated information of a candidate video, determining whether the candidate video is a video in the related video set.

In some embodiments, the method further comprises: for each video in the related video set as a current video, inputting associated information of the current video and the associated information of the first video into a third preset model to obtain a correlation degree between the current video and the first video; and ranking the each video in the related video set based on the correlation degree to determine the at least one second video. Usually, the second video having a greater correlation degree with the first video is ranked higher, so that when the current user watches the videos, the second video ranked higher is played in priority to cater to interests of the current user and achieve the purpose of improving a consumption experience of the current user.

In some embodiments, the method further comprises: in response to an operation of sliding a playing screen of a second video in the at least one second video in a preset direction, displaying a playing screen of a next second video according to a ranking order of the each video in the related video set. For example, the second videos are ranked according to the correlation degree of each second video in the related video set with the first video, wherein a second video “a” ranks first, that is, the second video “a” has the greatest correlation degree with the first video; a second video “b” ranks second, that is, the second video “b” has a second greatest correlation degree with the first video, and it can be deduced from the above that a second video “c” ranks third. In the case where the current user triggers the preset entrance identifier, a playing screen of the second video “a” is displayed, and when sliding the playing screen of the second video “a” in a preset direction (for example, upward), a playing screen of the second video “b” is displayed, and when sliding the playing screen of the second video “b” in the preset direction (for example, upward), a playing screen of the second video “c” is displayed.

By ranking the at least one second video according to the correlation degree between the at least one second video in the related video set and the first video, the second video having a greater correlation degree with the first video is ranked higher and watched by the current user earlier, so as to cater to the interests of the current user and achieve the purpose of improving the consumption experience of the current user.

The video display method provided in the embodiments of the present disclosure recommends the at least one second video to the current user based on the first video, thereby achieving a purpose of recommending videos to the current user. By limiting the display condition of the preset entrance identifier, the probability that the preset entrance identifier is triggered can be guaranteed. Specifically, when the target interest point associated with the first video is outside the preset range determined based on the target terminal, the preset entrance identifier is displayed on the playing screen of the first video, so that the current user can experience a convenient living service close to itself. By determining the at least one second video based on the associated information of the first video, the correlation between the at least one second video and the first video can be ensured, and a display effect can be improved, so as to cater to the interests of the current user and achieve the purpose of improving a consumption experience of the current user.

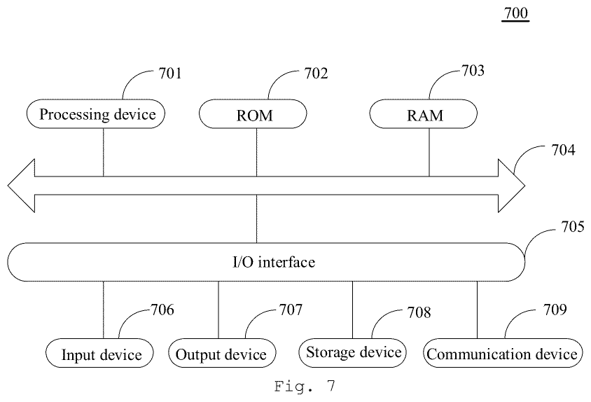

FIG. 6 is a schematic structural diagram of a video displaying apparatus provided in the embodiments of the present disclosure. The video display apparatus provided in the embodiments of the present disclosure can be set in a client. The video display apparatus in particular comprises a first determining module 610, a first displaying module 620 and a second displaying module 630.

The first determining module 610 is configured to, in response to a first video comprising a first preset object being played, determine whether a second preset object associated with the first video meets a preset condition; a first displaying module 620 is configured to in response to the second preset object associated with the first video meeting the preset condition, display a preset entrance identifier on a playing screen of the first video; a second displaying module 630 is configured to in response to a triggering acting on the preset entrance identifier, display at least one second video, wherein the at least one second video is at least one video associated with the first preset object, which is determined based on associated information of the first video.

In some embodiments, the second preset object associated with the first video is a target interest point associated with the first video, and the first determining module 610 is in particular configured to: determine whether the target interest point associated with the first video is outside a preset range determined based on the target terminal; in the case of determining that the target interest point associated with the first video is outside the preset range determined based on the target terminal, determine that the second preset object associated with the first video meets the preset condition.

In some embodiments, a third preset object associated with the second video is within the preset range determined based on the target terminal, and the third preset object is a target interest point associated with the second video.

In some embodiments, the video display apparatus further comprises: a predicting module configured to, before displaying the preset entrance identifier on the playing screen of the first video, determining whether the preset entrance identifier is displayed through a first preset model, based on a first feature of a current user and a second feature of the first video, wherein the current user is a user operating the target terminal, and in response to determining that the preset entrance identifier is displayed, the displaying the preset entrance identifier on the playing screen of the first video is performed.

In some embodiments, the preset entrance identifier comprises a keyword associated with the first preset object.

In some embodiments, the video display apparatus further comprises a second determining module configured to in response to displaying the preset entrance identifier on the playing screen of the first video, determine a related video set based on associated information of the first video, wherein the at least one second video is at least one video in the related video set, and the associated information of the first video comprises a tag corresponding to the first preset object in the first video, a text feature associated with the first video, a screen feature of the first video and a preset range feature where the target terminal is located.

In some embodiments, the second determining module is in particular configured to input the associated information of the first video into a second preset model to obtain the related video set; or
based on a similarity between the associated information of the first video and associated information of a candidate video, determine whether the candidate video is a video in the related video set.

In some embodiments, the video display apparatus further comprises: a third determining module configured to, for each video in the related video set as a current video, input associated information of the current video and the associated information of the first video into a third preset model to obtain a correlation degree between the current video and the first video; and
a ranking module configured to, rank the each video in the related video set based on the correlation degree to determine the at least one second video.

In some embodiments, the video display apparatus further comprises a switching module configured to, in response to an operation of sliding a playing screen of a second video in the at least one second video in a preset direction, display a playing screen of a next second video according to a ranking order of the each video in the related video set.

The video display apparatus provided in the embodiments of the present disclosure can execute the steps, executed by the client, in the video display method provided in the embodiments of the present disclosure, and has execution steps and beneficial effects, which are not repeated here.

FIG. 7 is a schematic structural diagram of an electronic device provided in some embodiments of the present disclosure. Referring to FIG. 7 in particular, it shows the schematic diagram of the structure that is suitable for realizing the electronic device 700 in the embodiments of the present disclosure. The electronic device 700 in the embodiments of the present disclosure can comprise, but is not limited to, a mobile terminal such as a mobile phone, a laptop computer, a digital broadcasting receiver, a PDA (Personal Digital Assistant), a PAD (tablet computer), a PMP (Portable Multimedia Player), a vehicle-mounted terminal (e.g. vehicle-mounted navigation terminal), a wearable electronic device, etc., and a fixed terminal such as a digital TV, a desktop computer, a smart home device, etc. The electronic device shown in FIG. 7 is only an example and should not impose any limitations on the functions and usage scope of the embodiments of the present disclosure.

As shown in FIG. 7, the electronic device 700 can comprise a processing device (e.g. a central processing unit, a graphics processor, etc.) 701, which can perform various appropriate actions and processes according to programs stored in a Read-Only Memory (ROM) 702 or programs loaded from a storage device 708 into a Random Access Memory (RAM) 703 to implement the method as described in the embodiments of the present disclosure. In the RAM 703 are also stored various programs and data required for operations of the electronic device 700. The processing device 701, ROM 702, and RAM 703 are connected to each other through a bus 704. An input/output (I/O) interface 705 is also connected to the bus 704.

Typically, the following devices can be connected to the I/O interface 705: an input device 706 comprising: for example, a touch screen, a touchpad, a keyboard, a mouse, a camera, a microphone, an accelerometer, a gyroscope, etc.; an output device 707 comprising: for example, a liquid crystal display (LCD), a speaker, a vibrator, etc.; a storage device 708 comprising: for example, a magnetic tape, a hard disk, etc.; and a communication device 709. The communication device 709 can allow the electronic device 700 to communicate wirelessly or wired with other devices to exchange data. Although FIG. 7 shows the electronic device 700 with various devices, it should be understood that it is not required to implement or have all the shown devices. More or fewer devices can be implemented or included as an alternative.

Specifically, according to the embodiments of the present disclosure, the process described above with reference to the flowchart can be realized as a computer software program. For example, the embodiments of the present disclosure comprise a computer program product, which comprises a computer program carried on a non-transient computer-readable medium, wherein the computer program comprises program codes for executing the video display method shown in the flowchart. In such embodiments, the computer program can be downloaded and installed from network through the communication device 709, or installed from the storage device 708, or installed from the ROM 702. When the computer program is executed by the processing device 701, the above functions defined in the method of the embodiments of the present disclosure are performed.

It should be noted that the above computer-readable medium mentioned in the present disclosure can be a computer-readable signal medium, a computer-readable storage medium, or any combination of both. The computer-readable storage medium, for example, can be, but not limited to, an electrical, magnetic, optical, electromagnetic, infrared, or semiconductor system, device, or component, or any combination thereof. A more specific example of the computer-readable storage medium may comprise, but is not limited to: an electrical connection with one or more wires, a portable computer disk, a hard disk, a Random Access Memory (RAM), a Read-Only Memory (ROM), an Erasable Programmable Read-Only Memory (EPROM or flash), a fiber optic, a Portable Compact Disk Read-Only Memory (CD-ROM), an optical storage device, a magnetic storage device, or any suitable combination thereof. In the present disclosure, the computer-readable storage medium can be any tangible medium containing or storing a program, which can be used by an instruction execution system, device, or component, or in combination with the same. While in the present disclosure, the computer-readable signal medium can comprise data signals propagated in the baseband or as a part of the carrier wave, which carry computer-readable program codes. The propagated data signals can take various forms, comprising but not limited to electromagnetic signals, optical signals, or any suitable combination thereof. The computer-readable signal medium can also be any computer-readable medium other than the computer-readable storage medium, which can send, propagate, or transmit a program used by or in combination with an instruction execution system, device, or component. The program codes contained in the computer-readable medium can be transmitted using any appropriate medium, comprising but not limited to: wire, optical cable, RF (Radio Frequency), etc., or any suitable combination thereof.

In some embodiments, a client and a server can communicate using any currently known or future developed network protocol, such as HTTP (HyperText Transfer Protocol), and can interconnect with any form or medium of digital data communication (such as communication network). Examples of the communication network comprise Local Area Network (“LAN”), Wide Area Network (“WAN”), internet (for example, the Internet), and end-to-end network (for example, ad hoc end-to-end network), as well as any currently known or future developed network.

The computer-readable medium mentioned above can be included in the aforesaid electronic device; it can also exist separately without being assembled into the electronic device.

The computer-readable medium mentioned above carries one or more programs, which, when executed by the electronic device, cause the electronic device to: in response to a first video comprising a first preset object being played, determine whether a second preset object associated with the first video meets a preset condition; in response to the second preset object associated with the first video meeting the preset condition, display a preset entrance identifier on a playing screen of the first video; and in response to a triggering acting on the preset entrance identifier, display at least one second video, wherein the at least one second video is at least one video associated with the first preset object, which is determined based on associated information of the first video.

In some embodiments, when the above one or more programs are executed by the electronic device, the electronic device can also implement other steps as described in the above embodiments.

The computer program codes for executing operations of the present disclosure may be written in one or more programming languages or combinations thereof, comprising, but not limited to, object-oriented programming languages such as Java, Smalltalk, C++, and conventional procedural programming languages such as C or similar programming languages. The program codes can be completely executed on a user's computer, partially executed on a user's computer, executed as an independent software package, partially executed on a user's computer and partially executed on a remote computer, or completely executed on a remote computer or server. In the case involving a remote computer, the remote computer can connect to the user's computer through any type of network (comprising Local Area Network (LAN) or Wide Area Network (WAN)), or can connect to an external computer (e.g. connect via the Internet using an Internet service provider).

The flowchart and block diagram in the accompanying drawings illustrate the possible architecture, functions, and operations of the system, method, and computer program product according to various embodiments of the present disclosure. At this point, each box in the flowchart or block diagram can represent a module, program segment, or part of codes that comprises one or more executable instructions for realizing a specified logical function. It should also be noted that in some alternative implementations, the functions indicated in the box can also occur in a different order from those indicated in the accompanying drawings. For example, two consecutive boxes can actually be executed in basically parallel, and sometimes they can also be executed in reverse order, depending on the function involved. It should also be noted that each box in the block diagram and/or flowchart, as well as the combination of boxes in the block diagram and/or flowchart, can be realized using a dedicated hardware based system that executes specified functions or operations, or can be realized using a combination of dedicated hardware and computer instructions.

The involved units described in the embodiments of the present disclosure can be realized in form of software or in form of hardware. Wherein, name of the unit does not constitute a limitation on the unit itself in a certain situation.

The above functions described herein can be at least partially executed by one or more hardware logic components. For example, non-restrictively, demonstration types of the hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), and the like.

In the context of the present disclosure, a machine readable medium can be a tangible medium that can include or store a program that can be used by an instruction execution system, device, or equipment or in combination with an instruction execution system, device, or equipment. The machine readable medium can be a machine readable signal medium or a machine readable storage medium. The machine readable medium can comprise but not limited to an electronic, magnetic, optical, electromagnetic, infrared, or semiconductor system, device, or equipment, or any suitable combination thereof. More specific examples of the machine readable storage medium can comprise electrical connection based on one or more wires, portable computer disk, hard disk, Random Access Memory (RAM), Read-Only Memory (ROM), Erasable Programmable Read-Only Memory (EPROM or flash memory), optical fiber, Compact Disc Read-Only Memory (CD-ROM), optical storage device, magnetic storage device, or any suitable combination thereof.

According to some embodiments of the present disclosure, the present disclosure provides a video display method, comprising: in response to a first video comprising a first preset object being played, determining whether a second preset object associated with the first video meets a preset condition; in response to the second preset object associated with the first video meeting the preset condition, displaying a preset entrance identifier on a playing screen of the first video; and in response to a triggering acting on the preset entrance identifier, displaying at least one second video, wherein the at least one second video is at least one video associated with the first preset object, which is determined based on associated information of the first video.

According to some embodiments of the present disclosure, in the video display method provided in the present disclosure, the second preset object associated with the first video is a target interest point associated with the first video, and the determining whether a second preset object associated with the first video meets a preset condition comprises: determining whether the target interest point associated with the first video is outside a preset range determined based on the target terminal; and in response to determining that the target interest point associated with the first video is outside the preset range determined based on the target terminal, determining that the second preset object associated with the first video meets the preset condition.

According to some embodiments of the present disclosure, in the video display method provided in the present disclosure, a third preset object associated with the second video is within the preset range determined based on the target terminal, and the third preset object is a target interest point associated with the second video.

According to some embodiments of the present disclosure, the video display method provided in the present disclosure, further comprises, before displaying the preset entrance identifier on the playing screen of the first video: determining whether the preset entrance identifier is displayed through a first preset model, based on a first feature of a current user and a second feature of the first video, wherein the current user is a user operating the target terminal, and in response to determining that the preset entrance identifier is displayed, the displaying the preset entrance identifier on the playing screen of the first video is performed.

According to some embodiments of the present disclosure, in the video display method provided in the present disclosure, the preset entrance identifier comprises a keyword associated with the first preset object.

According to some embodiments of the present disclosure, the video display method provided in the present disclosure, further comprises: in response to displaying the preset entrance identifier on the playing screen of the first video, determining a related video set based on associated information of the first video, wherein the at least one second video is at least one video in the related video set, and the associated information of the first video comprises a tag corresponding to the first preset object in the first video, a text feature associated with the first video, a screen feature of the first video and a preset range feature where the target terminal is located.

According to some embodiments of the present disclosure, in the video display method provided in the present disclosure, the determining a related video set based on associated information of the first video comprises: inputting the associated information of the first video into a second preset model to obtain the related video set; or based on a similarity between the associated information of the first video and associated information of a candidate video, determining whether the candidate video is a video in the related video set.

According to some embodiments of the present disclosure, the video display method provided in the present disclosure, further comprises: for each video in the related video set as a current video, inputting associated information of the current video and the associated information of the first video into a third preset model to obtain a correlation degree between the current video and the first video; and ranking the each video in the related video set based on the correlation degree to determine the at least one second video.

According to some embodiments of the present disclosure, in the video display method provided in the present disclosure, in response to an operation of sliding a playing screen of a second video in the at least one second video in a preset direction, displaying a playing screen of a next second video according to a ranking order of the each video in the related video set.

According to some embodiments of the present disclosure, the video display method provided in the present disclosure, further comprises: displaying the second preset object associated with the first video on the playing screen of the first video; and in response to a triggering on the second preset object, jumping from the playing screen of the first video to a page where the second preset object is located.

According to some embodiments of the present disclosure, the video display method provided in the present disclosure, further comprises: displaying the third preset object and a preset list entrance identifier on the playing screen of the second video; and in response to a triggering on the preset list entrance identifier, displaying an associated page, wherein the associated page comprises an information list associated with the first preset object.

According to some embodiments of the present disclosure, the present disclosure provides a video displaying apparatus, comprising: a first determining module configured to, in response to a first video comprising a first preset object being played, determine whether a second preset object associated with the first video meets a preset condition; a first displaying module configure to in response to the second preset object associated with the first video meeting the preset condition, display a preset entrance identifier on a playing screen of the first video; and a second displaying module configured to in response to a triggering acting on the preset entrance identifier, display at least one second video, wherein the at least one second video is at least one video associated with the first preset object, which is determined based on associated information of the first video.

According to some embodiments of the present disclosure, the present disclosure provides an electronic device, comprising:
a processor; and
a memory, for storing a computer program,
wherein the computer program, when executed by the processor, causes the processor to implement the video display method as provided in any of embodiments of the present disclosure.

According to some embodiments of the present disclosure, the present disclosure provides a computer-readable storage medium, on which a computer program is stored, wherein the computer program, when executed by a processor, causes the processor to implement the video display method as provided in any of embodiments of the present disclosure.

According to some embodiments of the present disclosure, the present disclosure provides a computer program, comprising: instructions, which when executed by a processor, cause the processor to implement the video display method as provided in any of embodiments of the present disclosure.

The above description is only for explaining the preferred embodiments of the present disclosure and the technical principles used. Those skilled in the art should understand that the scope of disclosure involved in the present disclosure is not limited to technical solutions formed by specific combinations of the aforementioned technical features, and should also cover other technical solutions formed by arbitrary combination of the aforementioned technical features or their equivalent features when not departing from the disclosed concept. For example, a technical solution is formed by exchanging the above features with the technical features with similar functions disclosed (but not limited to) in the present disclosure.

Furthermore, although the operations are depicted in a specific order, this should not be understood as requiring them to be executed in the specific order shown or in sequential order. In certain environments, multitasking and parallel processing may be advantageous. Similarly, although several specific implementation details are included in the above discussion, these should not be construed as limitations on the scope of the present disclosure. Some features described in the context of individual embodiments can also be combined to be implemented in a single embodiment. On the contrary, various features described in the context of a single embodiment can also be implemented separately or in multiple embodiments in any suitable manner of sub-combination.

Although the subject matter has been described in language specific to structural features and/or method logical actions, it should be understood that the subject matter defined in the attached claims may not necessarily be limited to the specific features or actions described above. On the contrary, the specific features and actions described above are only exemplary forms of implementing the claims.

1. A media item display method applied to a target terminal, comprising:
in response to a first media item comprising a first preset object being played, determining whether a second preset object associated with the first media item meets a preset condition;
in response to the second preset object associated with the first media item meeting the preset condition, displaying a preset identifier on a playing screen of the first media item; and
in response to a triggering acting on the preset identifier, displaying at least one second media item, wherein the at least one second media item is at least one media item associated with the first preset object, which is determined based on associated information of the first media item.

2. The media item display method according to claim 1, wherein the second preset object associated with the first media item is a target interest point associated with the first media item, and the determining whether a second preset object associated with the first media item meets a preset condition comprises:
determining whether the target interest point associated with the first media item is outside a preset range determined based on the target terminal; and
in response to determining that the target interest point associated with the first media item is outside the preset range determined based on the target terminal, determining that the second preset object associated with the first media item meets the preset condition.

3. The media item display method according to claim 2, wherein a third preset object associated with the second media item is within the preset range determined based on the target terminal, and the third preset object is a target interest point associated with the second media item.

4. The media item display method according to claim 1, further comprising, before displaying the preset identifier on the playing screen of the first media item:
determining whether the preset identifier is displayed through a first preset model, based on a first feature of a current user and a second feature of the first media item, wherein the current user is a user operating the target terminal, and in response to determining that the preset identifier is displayed, the displaying the preset identifier on the playing screen of the first media item is performed.

5. The media item display method according to claim 1, wherein the preset identifier comprises a keyword associated with the first preset object.

6. The media item display method according to claim 1, further comprising: in response to displaying the preset identifier on the playing screen of the first media item,
determining a related media item set based on associated information of the first media item, wherein the at least one second media item is at least one media item in the related media item set, and the associated information of the first media item comprises a tag corresponding to the first preset object in the first media item, a text feature associated with the first media item, a screen feature of the first media item and a preset range feature where the target terminal is located.

7. The media item display method according to claim 6, wherein the determining a related media item set based on associated information of the first media item comprises:
inputting the associated information of the first media item into a second preset model to obtain the related media item set; or
based on a similarity between the associated information of the first media item and associated information of a candidate media item, determining whether the candidate media item is a media item in the related media item set.

8. The media item display method according to claim 6, further comprising:
for each media item in the related media item set as a current media item, inputting associated information of the current media item and the associated information of the first media item into a third preset model to obtain a correlation degree between the current media item and the first media item; and
ranking the each media item in the related media item set based on the correlation degree to determine the at least one second media item.

9. The media item display method according to claim 8, further comprising:
in response to an operation of sliding a playing screen of a second media item in the at least one second media item in a preset direction, displaying a playing screen of a next second media item according to a ranking order of the each media item in the related media item set.

10. The media item display method according to claim 1, further comprising:
displaying the second preset object associated with the first media item on the playing screen of the first media item; and
in response to a triggering on the second preset object, jumping from the playing screen of the first media item to a page where the second preset object is located.

11. The media item display method according to claim 3, further comprising:
displaying the third preset object and a preset list identifier on the playing screen of the second media item; and
in response to a triggering on the preset list identifier, displaying an associated page, wherein the associated page comprises an information list associated with the first preset object.

12. (canceled)

13. An electronic device, comprising:
a processor, and
a storage device configured to store a computer program,
wherein the computer program, when executed by the processor, causes the processor to:
in response to a first media item comprising a first preset object being played, determine whether a second preset object associated with the first media item meets a preset condition;
in response to the second preset object associated with the first media item meeting the preset condition, display a preset identifier on a playing screen of the first media item; and
in response to a triggering acting on the preset identifier, display at least one second media item, wherein the at least one second media item is at least one media item associated with the first preset object, which is determined based on associated information of the first media item.

14. A non-transitory computer-readable storage medium, on which a computer program is stored, wherein, the computer program, when executed by a processor, causes the processor to:
in response to a first media item comprising a first preset object being played, determine whether a second preset object associated with the first media item meets a preset condition;
in response to the second preset object associated with the first media item meeting the preset condition, display a preset identifier on a playing screen of the first media item; and
in response to a triggering acting on the preset identifier, display at least one second media item, wherein the at least one second media item is at least one media item associated with the first preset object, which is determined based on associated information of the first media item.

15. (canceled)

16. The electronic device according to claim 13, wherein the second preset object associated with the first media item is a target interest point associated with the first media item, the determining whether a second preset object associated with the first media item meets a preset condition comprising:
determining whether the target interest point associated with the first media item is outside a preset range determined based on the target terminal; and
in response to determining that the target interest point associated with the first media item is outside the preset range determined based on the target terminal, determining that the second preset object associated with the first media item meets the preset condition.

17. The electronic device according to claim 16, wherein a third preset object associated with the second media item is within the preset range determined based on the target terminal, and the third preset object is a target interest point associated with the second media item.

18. The electronic device according to claim 13, wherein the computer program, when executed by the processor, further causes the processor to, before displaying the preset identifier on the playing screen of the first media item:
determining whether the preset identifier is displayed through a first preset model, based on a first feature of a current user and a second feature of the first media item, wherein the current user is a user operating the target terminal,
wherein in response to determining that the preset identifier is displayed, the displaying the preset identifier on the playing screen of the first media item is performed.

19. The electronic device according to claim 13, wherein the preset identifier comprises a keyword associated with the first preset object.

20. The electronic device according to claim 13, wherein the computer program, when executed by the processor, further causes the processor to, in response to displaying the preset identifier on the playing screen of the first media item:
determine a related media item set based on associated information of the first media item, wherein the at least one second media item is at least one media item in the related media item set, and the associated information of the first media item comprises a tag corresponding to the first preset object in the first media item, a text feature associated with the first media item, a screen feature of the first media item and a preset range feature where the target terminal is located.

21. The electronic device according to claim 20, wherein the determining a related media item set based on associated information of the first media item comprises:
inputting the associated information of the first media item into a second preset model to obtain the related media item set; or
based on a similarity between the associated information of the first media item and associated information of a candidate media item, determining whether the candidate media item is a media item in the related media item set.

22. The electronic device according to claim 20, wherein the computer program, when executed by the processor, further causes the processor to:
in response to an operation of sliding a playing screen of a second media item in the at least one second media item in a preset direction, display a playing screen of a next second media item according to a ranking order of the each media item in the related media item set.
